(19) United States
(12) Patent Application Publication
(10) Pub. No.: US 2008/0114097 A1
(43) Pub. Date: May 15, 2008

(54) Aqueous Impregnating Resin Solution

(75) Inventors: Ralph Lunkwitz, Neustadt (DE); Alain Robert, Niederkirchen (DE); Jakob Decher, Bobenheim-Roxheim (DE); Tilo Horstmann, Bad Durkheim (DE); Martin Reif, Romerberg (DE); Christof Jackh, Heidelberg (DE)

Correspondence Address: CONNOLLY BOVE LODGE & HUTZ, LLP, P O BOX 2207, WILMINGTON, DE, 19899, US

(73) Assignee: BASF Aktiengesellschaft, Ludwigshafen (DE)

(21) Appl. No.: 11/576,935

(22) PCT Filed: Oct. 6, 2005
(86) PCT No.: PCT/EP05/10764

§ 371 Date: Apr. 9, 2007

(30) Foreign Application Priority Data
Oct. 8, 2004 (DE) 10 2004 049 340.5
Jun. 23, 2005 (DE) 10 2005 029 629.7

(51) Int. Cl. C08L 1/08; C08G 12/30

(52) U.S. Cl. 524/35; 528/254

(57) ABSTRACT

The invention relates to an aqueous impregnating resin solution containing (A) between 77.5 and 99.8 wt. %, in relation to the impregnating resin solution, of aqueous condensates based on melamine and formaldehyde; (B) between 0.1 and 20 wt. %, in relation to the impregnating resin solution, of at least one specific quaternary ammonium compound; and (C) between 0.1 and 2.5 wt. %, in relation to the impregnating resin solution, of an aqueous hardener solution. The invention also relates to an aqueous impregnating resin solution consisting of constituents (A) and (B), and to an aqueous hardener mixture consisting of constituents (B) and (C). The invention further relates to an impregnating resin film containing fibrous substances containing cellulose and impregnated with the aqueous impregnating resin solution, and to the use of the aqueous impregnating resin solution, or impregnating resin film, for the antistatic finishing of coated materials.

The present invention relates to aqueous impregnating resin liquors comprising
(A) from 77.5 to 99.8% by weight, based on the impregnating resin liquor, of aqueous condensates based on melamine and formaldehyde
(B) from 0.1 to 20% by weight, based on the impregnating resin liquor, of one or more quaternary ammonium compounds of the general formula I

(R₁R₂R₃R₄N⁺)X⁻ (I)
where
R₁ is a C₉-C₂₄-alkyl or alkoxy radical or an alkylene oxide radical H(OCₘH₂ₘ)ₙ
   where m=1 to 6 and
   n—1 to 10,
      if R₂ is not an alkylene oxide radical where n=1, and
   n=2 to 10,
      if R₂ is an alkylene oxide radical where n=1,
R₂ is a C₁-C₂₄-alkyl or alkoxy radical or an alkylene oxide radical H(OCₘH₂ₘ)ₙ where m=1 to 6 and n=1 to 10, or a benzyl or phenyl radical,
R₃ and R₄ are a C₁-C₃-alkyl radical and
X is one equivalent of an anion
(C) from 0.1 to 2.5% by weight, based on the impregnating resin liquor, of an aqueous curing agent solution.

The invention furthermore relates to an aqueous impregnating resin mixture comprising components (A) and (B); and an aqueous curing agent mixture comprising components (B) and (C). The invention moreover relates to an impregnating resin film comprising cellulose-containing fibers impregnated with the aqueous impregnating resin liquor. The invention furthermore relates to the use of the aqueous impregnating resin liquor or of the impregnating resin film for the antistatic treatment of coated materials.

The dangers of the buildup of an electrostatic charge are varied and imply an increasing risk in environments in which electronic apparatuses are used.

In addition to the danger of damage to sensitive electronic circuits, such as, for example, in computers, the ignition of readily flammable cleaning agents and solvents by electric sparks cannot be ruled out. The relatively strong tendency to soiling due to the attractive effect on small particles, such as dust, smoke particles and mist drops, may be mentioned as a further disadvantage. Furthermore, prolonged presence in the vicinity of highly charged products can lead to headaches and indisposition. Sparkover can furthermore cause sensations of pain, which in turn may, if appropriate, lead to dangerous situations owing to alarm.

The prior art adopts two approaches for reducing the possibility of the buildup of electrostatic charge. One approach consists in the use of a further protective layer. U.S. Pat. No. 5,089,327 describes a reduced charge buildup with the use of paper which was saturated with a water-soluble polymer of quaternary polycationic ammonium compounds. DE-A 101 15 567 discloses that a layer of polymeric material, preferably polyaniline or polypyrrole, applied to the decorative paper reduces the possibility of the buildup of a static charge. The other approach consists in modifying the impregnating resin used. DE-A 41 17 844 states that a reduced charge buildup can be achieved using a mixture of a melamine/formaldehyde condensate and a quaternary low molecular weight ammonium compound. The quaternary low molecular weight ammonium compound has the general formula (R¹ₙR²₄₋ₙN⁺)X⁻, where n is 0, 1, 2 or 3, R¹ is a C₁-C₈-alkyl radical or a benzyl radical, R² is a C₁-C₈-alkyl radical which carries a hydroxyl or an amido group, and X is one equivalent of an anion.

In addition to avoidance of electrostatic charge buildup, for example, the customers for floorcoverings desire that the floorcoverings furthermore have antimicrobial activity.

It was an object of the present invention to provide an impregnating resin liquor and an impregnating resin film prepared therefrom which are suitable for the production of film-coated materials having little tendency to the buildup of an electrostatic charge. Furthermore, the antistatic agent was to be used in smaller amounts than those described in the prior art and were advantageously to be halogen-free. Furthermore, it was intended to find an impregnating resin film which has antimicrobial activity.

Accordingly, the impregnating resin liquor defined at the outset was found.

Aqueous melamine/formaldehyde condensates are suitable as component (A), it being possible for the molar ratio of melamine to formaldehyde to be from 1:1 to 1:2.2. The condensation of melamine and formaldehyde is effected under conditions known per se, in a basic medium, at a pH of from 8 to 10 and temperatures of from 80 to 100° C.

Furthermore, cocondensates in which from 1 to 10% by weight, based on melamine, of urea may have been incorporated by condensation are also suitable. The preparation of such cocondensates is known and is usually carried out at a pH of from 8 to 10 and temperatures of from 70 to 100° C.

The end point of the respective condensation reaction can be determined via the turbidity temperature by adding 5 times the amount of water to 1 g of the reaction mixture, whereupon the temperature at which this mixture becomes turbid is measured. Usually, condensation is effected up to a turbidity temperature of from 40 to 60° C.

In the preparation of the condensates, all additives, modifiers and assistants known to a person skilled in the art are concomitantly used in amounts of from 2 to 8% by weight, based on the solids content.

The preparation of the aqueous condensates is advantageously effected in such a way that solutions having solids contents of from 40 to 70% by weight are obtained. Here, solids content is defined as the dry residue which is determined by drying 1 g of resin solution for two hours in a drying oven at 120° C.

The amount of (A) is chosen so that from 77.5 to 99.8% by weight, preferably from 80 to 99.5% by weight, particularly preferably from 85 to 99.2% by weight, based on the impregnating resin liquor, of (A) are present.

Compounds of the general formula (I):

(R₁R₂R₃R₄N⁺)X⁻ (I)

where

### R₁ is a C₉-C₂₄-alkyl or alkoxy radical or an alkylene oxide radical H(OCₘH₂ₘ)ₙ where m=1 to 6 and n=1 to 10, if R₂ is not an alkylene oxide radical where n=1, and n=2 to 10, if R₂ is an alkylene oxide radical where n=1,

### R₂ is a C₁-C₂₄-alkyl or alkoxy radical or an alkylene oxide radical H(OCₘH₂ₘ)ₙ where m=1 to 6 and n=1 to 10, or is a benzyl or phenyl radical,

### R₃ and R₄ are a C₁-C₃-alkyl radical and

### X is one equivalent of an anion,

are suitable as quaternary ammonium compound (B),
R₁ is advantageously an unsubstituted C₉-C₂₄-alkyl or alkoxy radical, a methyl-substituted C₈-C₂₃-alkyl or alkoxy radical or a C₁-C(₈₋ₓ)-alkyl-substituted C₈-C(₁₆₊ₓ)-alkyl or alkoxy radical where x is from 0 to 6, the alkyl or alkoxy radical advantageously being substituted in position 2, or is an alkylene oxide radical of the formula H(OCₘH₂ₘ), where m=1 to 4 and n=1 to 10; preferably where n=1 to 6, in particular where n=1 to 3, if R₂ is not an alkylene oxide radical where n=1, and n=2 to 10, preferably n=2 to 6, in particular n=2 or 3, if R₂ is an alkylene oxide radical where n=1. Particularly preferably, m2. In the case of a substituted alkyl or alkoxy chain, advantageously one which is substituted in position 2, the main chain advantageously consists of a C₈-C₂₀-alkyl or alkoxy chain; the alkyl or alkoxy chain may optionally be substituted by a C₁-C₄-alkyl radical. R₁ is preferably an unsubstituted or C₁-C₄-alkyl-substituted C₁₂-C₂₀ saturated or unsaturated alkyl or alkoxy radical or an alkylene oxide radical of the formula H(OCₘH₂ₘ)ₙ where m=2 and n=1 to 3 if R₂ is not an alkylene oxide radical where n=1. R₁ is particularly preferably an unsubstituted C₁₂-C₂₀ saturated or unsaturated alkyl or alkoxy radical. In particular, R₁ is an unsubstituted or methyl-substituted hexadecyl, heptadecyl, octadecyl, nonadecyl or icosanyl radical.

R₂ is advantageously a C₁-C₂₀-alkyl or alkoxy radical, an alkylene oxide radical of the formula H(OCₘH₂ₘ)ₙ where m=1 to 4, in particular 2, and n=1 to 10, preferably 1 to 6, in particular 1 to 3, or a phenyl or benzyl radical. The alkyl, alkoxy, phenyl or benzyl radicals may be substituted or unsubstituted.

R₃ and R₄ are preferably methyl or ethyl radicals, in particular methyl radicals.

X is one equivalent of an anion. Anions of mineral acid, such as halide anions, and nitrate, sulfate, hydrogen sulfate, phosphate, hydrogen phosphate, dihydrogen phosphate or perchlorate, are suitable. Furthermore, alkylsulfates, such as, for example, methylsulfate or ethylsulfate, or alkanesulfonates, such as methanesulfonate or ethanesulfonate, or arylsulfonates, such as toluenesulfonates, are suitable. Anions of organic acids, such as formate, oxalate, acetate or maleate, are also suitable. Hydroxide ions are furthermore suitable. Sulfates, in particular ethylsulfate, sulfonates, in particular methylsulfonate, and hydroxide ions are particularly preferred.

An unsubstituted or methyl-substituted C₁₆-C₂₀-alkyl-dimethyl-C₁-C₁₂-alkylammonium compound or a mono- or polyethoxylated, in particular monoethoxylated, dimethyl-C₁-C₁₂-alkylammonium compound is particularly preferred as component (B). In particular, an unsubstituted or methyl-substituted C₁₆-C₂₀-alkyl-dimethyl-C₁-C₁₂-alkyl-ammonium compound is used as component (B)

The component (B) may also consist of mixtures of quaternary ammonium compounds according to the formula (I).

The amount of (B) is chosen so that from 0.1 to 20% by weight of (B), based on the solid of component (B), preferably from 0.3 to 18% by weight, particularly preferably from 0.5 to 13% by weight, very particularly preferably from 0.5 to 3, in particular from 1 to less than 2% by weight, based on the impregnating resin liquor, are present.

The component (B) may be used in solid form or in the form of a solution.

All curing agents known to the person skilled in the art may be used as component (C). Suitable curing agents are, for example, Brønsted acids, such as organic sulfonic acids and carboxylic acids, and the anhydrides thereof, for example maleic acid, maleic anhydride and formic acid, ammonium compounds, for example ammonium sulfate, ammonium sulfite, ammonium nitrate, ethanolammonium chloride and dimethylethanolammonium sulfite, and combinations of curing agents, such as morpholine/p-toluenesulfonic acid. Furthermore, primary, secondary and/or tertiary amines, hydroxyalkanolamines, monoethanolamine, methylethanolamine and/or morpholine can advantageously be used as component (C).

Mixtures of different curing agents can also be used.

The curing agents can be used in amounts of from 0.1 to 2.5%, advantageously 0.2 to 2.0%, preferably 0.3 to 2.0%, by weight of aqueous curing agent solution, based on the aqueous impregnating liquor. It is known to a person skilled in the art that the dose of curing agent can be adapted to the respective requirements for the application, it being possible for the reactivity of the impregnating resin/curing agent mixtures to be appropriately established via the measurement of the turbidity times and gelling times.

The impregnating resin liquor according to the invention has a solids content of from 40 to 70% by weight and viscosities in the range from 20 to 200 mPa·s (20® C.).

For the preparation of the impregnating resin liquor, for example, the components (A), (B) and (C) are mixed with one another.

Furthermore, an impregnating resin mixture comprising the components (A) and (B) can first be prepared. The component (B) can be mixed in solid form or in the form of a solution with the aqueous condensate (A) or can be added at the beginning of the condensation reaction of melamine and formaldehyde.

The present invention therefore furthermore relates to an aqueous impregnating resin mixture comprising
(A) from 80 to 99.9% by weight, based on the impregnating resin mixture, of aqueous condensates based on melamine and formaldehyde
(B) from 0.1 to 20% by weight, based on the impregnating resin mixture, of one or more quaternary ammonium compounds of the general formula I

(R₁R₂R₃R₄N⁺)X⁻ (I)
where
R₁ is a C₉-C₂₄-alkyl or alkoxy radical or an alkylene oxide radical H(OCₘH₂ₘ)ₙ
   where m=1 to 6 and
   n=1 to 10,
   if R₂ is not an alkylene oxide radical where n=1, and
   n=2 to 10,
   if R₂ is an alkylene oxide radical where n=1,
R₂ is a C₁-C₂₄-alkyl or alkoxy radical or an alkylene oxide radical H(OCₘH₂ₘ)ₙ where m=1 to 6 and n=1 to 10, or a benzyl or phenyl radical,
R₃ and R₄ are a C₁-C₃-alkyl radical and
X is one equivalent of an anion.

The impregnating resin mixture according to the invention has a solids content of from 40 to 70% by weight and viscosities in the range from 20 to 200 mPa·s (20° C.).

For the preparation of the impregnating resin liquor, the component (C) is advantageously added to the impregnating resin mixture shortly before the impregnation of the cellulose-containing fibers. The impregnating resin mixture has a shelf-life of from 3 to 4 weeks.

Preferably, however, an aqueous curing agent mixture comprising the components (B) and (C) is first prepared.

The present invention therefore furthermore relates to an aqueous curing agent mixture comprising
(B) from 60 to 90% by weight, advantageously from 70 to 85% by weight, preferably from 75 to 83% by weight, based on the curing agent mixture, of one or more quaternary ammonium compounds of the general formula I

(R₁R₂R₃R₄N⁺)X⁻ (I)
where
R₁ is a C₉-C₂₄-alkyl or alkoxy radical or an alkylene oxide radical H(OCₘH₂ₘ)ₙ
   where m=1 to 6 and
   n=1 to 10,
      if R₂ is not an alkylene oxide radical where n=1, and
   n=2 to 10,
      if R₂ is an alkylene oxide radical where n=1,
R₂ is a C₁-C₂₄-alkyl or alkoxy radical or an alkylene oxide radical H(OCₘH₂ₘ)ₙ where m=1 to 6 and n=1 to 10, or a benzyl or phenyl radical,
R₃ and R₄ are a C₁-C₃-alkyl radical and
X is one equivalent of an anion.
(C) from 10 to 40% by weight, advantageously from 15 to 30% by weight, preferably from 17 to 25% by weight, based on the curing agent mixture, of an aqueous curing agent solution.

The curing agent mixture according to the invention has a solids content of from 50 to 90% by weight.

The curing agent mixture according to the invention is a clear product and has a shelf-life of at least 6 to 12 months.

For the preparation of the impregnating resin liquor, the component (A) is advantageously added to the curing agent mixture shortly before the impregnation of the cellulose-containing fibers.

Expediently, the impregnating resin liquor according to the invention is prepared shortly before the impregnation. Consequently, the impregnator stores the impregnating resin mixture according to the invention or the impregnating resin and the curing agent or the curing agent mixture according to the invention separately. The use of the curing agent mixture according to the invention has the advantage that the impregnator can adjust the ratio of the component (B) in comparison with the component (A) for each impregnation. The amount of curing agent used in the impregnating liquor according to the invention can, it appropriate, be increased by further addition of curing agent component (C).

Furthermore, further additives and/or assistants known to the person skilled in the art can be added to the impregnating resin liquor according to the invention.

Furthermore, the invention relates to an impregnating resin film comprising cellulose-containing fibers impregnated with the aqueous impregnating resin liquor.

The impregnating resin film can be produced by all processes known to the person skilled in the art.

The impregnation is effected as a rule in such a way that the cellulose-containing fibers, such as, for example, overlay papers are impregnated with the impregnating resin liquor according to the invention. For example, overlay papers having a basis weight in the range from 30 to 80 g/m² are impregnated with from 200 to 400% by weight, based on the paper weight, of the impregnating liquor, at room temperature. The impregnated paper is then dried to a residual moisture content of about 5 to 10% by weight. The conventional impregnating plants which introduce the desired amount of resin onto and into the papers in the so-called one-stage or two-stage process are suitable for the impregnation. The advantage of the two-stage process is that, if appropriate, different impregnating resin solutions can be used for the preliminary and subsequent impregnation.

Usually, the cellulose-containing fibers are impregnated in such a way that the impregnating resin film advantageously comprises
(i) from 20 to 50% by weight, preferably from 25 to 40% by weight, based on the impregnating resin film, of cellulose-containing fibers,
(ii) from 30 to 79.9% by weight, preferably from 50 to 74.8% by weight, based on the impregnating resin film, of condensates based on melamine and formaldehyde, and
(iii) from 0.1 to 20% by weight, preferably from 0.2 to 10% by weight, in particular from 0.2 to 2% by weight, based on the impregnating resin film, of one or more quaternary ammonium compounds of the general formula I

(R₁R₂R₃R₄N⁺)X⁻ (I)
where
R₁ is a C₉-C₂₄-alkyl or alkoxy radical or an alkylene oxide radical H(OCₘH₂ₘ)ₙ
where m=1 to 6 and
n=2 to 10,
if R₂ is not an alkylene oxide radical where n=1, and
n=2 to 10,
if R₂ is an alkylene oxide radical where n=1,
R₂ is a C₁-C₂₄-alkyl or alkoxy radical or an alkylene oxide radical H(OCₘH₂ₘ)ₙ where m=1 to 6 and n=1 to 10, or a benzyl or phenyl radical,
R₃ and R₄ are a C₁-C₃-alkyl radical and
X is one equivalent of an anion.

If appropriate, the component (iii) may also be present in the cellulose-containing fibers.

The invention furthermore relates to the use of the impregnating resin liquor according to the invention for the production of film-coated materials having antistatic surfaces.

The manner in which the coating of the materials with the impregnating resin films according to the invention is effected is known to a person skilled in the art. The impregnating resin films according to the invention produced in this manner are then usually applied in hot or cold form to the substrate. Advantageously, the films are pressed with the material at elevated temperatures of, for example, from 150 to 210° C. and/or elevated pressures of, for example, from 10 to 100 bar, preferably from 15 to 30 bar, during a pressing time of, for example, from 10 seconds to 90 minutes.

Advantageous substrates are wood-based materials, such as, for example, wood fibers or particle boards, MDF boards or HDF boards.

Laminates having a reduced buildup of electrostatic charge can be particularly advantageously produced using the impregnating resin films according to the invention.

Consequently, the invention furthermore relates to laminates which comprise the impregnating resin film according to the invention.

The laminate according to the invention furthermore has antimicrobial activity.

The laminates according to the invention meet the conventional requirements for application, such as, for example, good gloss, no losses of transparency and good water resistance, and do not exhibit any graying.

### EXAMPLES

### Preparation of Component (A)

A mixture of 730 g of 40% by weight aqueous formaldehyde and 334 g of water was thermostated at 30° C. The pH of the mixture was adjusted to about 9.5 with 25% by weight aqueous sodium hydroxide solution. 790 g of melamine were then added. The reaction mixture was then heated to 100° C., the pH slowly decreasing. Stirring was effected for about 60 min at a pH of about 8.6 to 8.8. As soon as a sample of the reaction mixture had a turbidity temperature of 50° C., the reaction mixture was cooled to room temperature.

### Component (B):

TABLE I
Antistatic agent (according to the invention)

| Example | Antistatic agent |
|---|---|
| 1 | Soybean alkyldimethylethylammonium ethylsulfate (80-90%) |
| | Dipropylene glycol (10-20%) |
| 2 | Octadecyltriethylammonium ethylsulfate (21%) |
| | 2-Propanol (40%) |
| | Water (39%) |
| 3 | Coconut alkyldimethylethylammonium ethylsulfate (35%) |
| | Water (65%) |
| 4 | 2-Hydroxyethyldimethyloctylammonium methylsulfonate |
| | (100%) |

### Component (C):

### Dimethylethanolammonium Sulfite (85% by Weight)

### Preparation of the Impregnating Liquor:

For the preparation of the impregnating liquor, the melamine/formaldehyde condensate was adjusted with water to a solids content of 55% by weight. 1.5% by weight, based on the impregnating resin solution, of an antistatic agent (1) to (4) were added to the melamine/formaldehyde condensate. 0.4% by weight, based on the impregnating resin solution, of an 85% strength by weight aqueous solution of a curing agent and 0.3% by weight, based on the resin solution, of a commercial wetting agent were then added to the impregnating resin solutions.

TABLE II
Comparative examples

| Example | Characteristics/Antistatic agent |
|---|---|
| 5 | According to DE 41 17 844 |
| 6 | Antistatic laminate board from Witex, established on |
| | the market |
| 7 | Commercial aminoplast resin without antistatic additive |

### Testing of Performance Characteristics:

Commercial overlay papers having a basis weight of 46 g/m² were impregnated. The resin coat was from 250 to 350% and the residual moisture content was adjusted to about 5-10%. The overlay films produced in this manner were pressed under 20 bar at 180° C. and for a pressing time of 50 seconds onto conventional laminatable fiber boards by the short-cycle process.

The antistatic properties of the surfaces thus produced are listed in table III. The antistatic properties were investigated in a test based on DIN IEC 61340-4-1. In these investigations, the charge buildup on persons from laboratory sample boards (30×40 cm) is measured directly.

TABLE III
Antistatic properties

| Example | Voltage peaks [V] | Variations [V] | Δ voltage [V] |
|---|---|---|---|
| 1 | 62 | 26-62 | 36 |
| 2 | 80 | 26-80 | 54 |
| 3 | 91 | 26-91 | 65 |
| 4 | 113 | 33-113 | 80 |
| 5 | 215 | 36-215 | 179 |
| 6 | 200 | 100-200 | 100 |
| 7 | 1000 | 350-1000 | 650 |

1-12. (canceled)

13. An aqueous impregnating resin liquor comprising
(A) from 77.5 to 99.8% by weight, based on the impregnating resin liquor, of aqueous condensates based on melamine and formaldehyde,
(B) from 0.1 to 20% by weight, based on the impregnating resin liquor, of one or more quaternary ammonium compounds of the general formula I
(R₁R₂R₃R₄N⁺)X⁻ (I)
wherein
R₁ is a C₈-C₂₄-alkyl or alkoxy radical or an alkylene oxide radical H(OCₘH₂ₘ)ₙ
wherein
m=1 to 6 and
n=1 to 10,
if R₂ is not an alkylene oxide radical where n=1, and
n=2 to 10,
if R₂ is an alkylene oxide radical where n=1,
R₂ is a C₁-C₂₄-alkyl or alkoxy radical or an alkylene oxide radical H(OCₘH₂ₘ)ₙ where m=1 to 6 and n=1 to 10, or a benzyl or phenyl radical,
R₃ and R₄ are a C₁-C₃-alkyl radical and
X is one equivalent of an anion,
(C) from 0.1 to 2.5% by weight, based on the impregnating resin liquor, of an aqueous curing agent solution.

14. The aqueous impregnating resin liquor according to claim 13, wherein R₁ being an unsubstituted C₉-C₂₄-alkyl or alkoxy radical, a methyl-substituted C₈-C₂₃-alkyl or alkoxy radical or a C₁-C(₈₋ₓ)-alkyl-substituted C₈-C(₁₆₊ₓ)-alkyl or alkoxy radical where x is 0 to 6 in component (B).

15. The aqueous impregnating resin liquor according to claim 13, wherein R₃ and R₄ being a methyl radical or ethyl radical.

16. The aqueous impregnating resin liquor according to claim 14, wherein R₃ and R₄ being a methyl radical or ethyl radical.

17. The aqueous impregnating resin liquor according to claim 13, wherein said component (B) is an unsubstituted or methyl-substituted C₁₆-C₂₀-alkyl-dimethyl-C₁-C₁₂-alkylammonium compound or a monoethoxylated dimethyl-C₁-C₁₂-alkylammonium compound.

18. The aqueous impregnating resin liquor according to claim 13, wherein X is sulfate, sulfonate or hydroxide ions.

19. The aqueous impregnating resin liquor according to claim 16, wherein X is sulfate, sulfonate or hydroxide ions.

20. The aqueous impregnating resin liquor according to claim 13, wherein said component (B) being used in an amount of from 0.5 to 3% by weight.

21. The aqueous impregnating resin liquor according to claim 19, wherein said component (B) being used in an amount of from 0.5 to 3% by weight.

22. An aqueous impregnating resin mixture comprising
(A) from 80 to 99.9% by weight, based on the impregnating resin mixture, of aqueous condensates based on melamine and formaldehyde
(B) from 0.1 to 20% by weight, based on the impregnating resin mixture, of one or more quaternary ammonium compounds of the general formula I
(R₁R₂R₃R₄N⁺)X⁻ (I)
where
R₁ is a C₉-C₂₄-alkyl or alkoxy radical or an alkylene oxide radical H(OCₘH₂ₘ)ₙ
where m=1 to 6 and
n=1 to 10,
if R₂ is not an alkylene oxide radical where
n=1, and
n=2 to 10,
if R₂ is an alkylene oxide radical where n=1,
R₂ is a C₁-C₂₄-alkyl or alkoxy radical or an alkylene oxide radical H(OCₘH₂ₘ)ₙ where m=1 to 6 and n=1 to 10, or a benzyl or phenyl radical,
R₃ and R₄ are a C₁-C₃-alkyl radical and
X is one equivalent of an anion.

23. An impregnating resin film comprising cellulose-containing fibers impregnated with the aqueous impregnating resin liquor according to claim 13.

24. The impregnating resin film according to claim 23, comprising
(i) from 20 to 40% by weight, based on the impregnating resin film, of cellulose-containing fibers,
(ii) from 40 to 79.9% by weight, based on the impregnating resin film, of condensates based on melamine and formaldehyde, and
(iii) from 0.1 to 20% by weight based on the impregnating resin film, of one or more quaternary ammonium compounds of the general formula I
(R₁R₂R₃R₄N⁺)X⁻ (I)
where
R₁ is a C₉-C₂₄-alkyl or alkoxy radical or an alkylene oxide radical H(OCₘH₂ₘ)ₙ
where m=1 to 6 and
n=1 to 10,
if R₂ is not an alkylene oxide radical where n=1, and
n=2 to 10,
if R₂ is an alkylene oxide radical where n=1,
R₂ is a C₁-C₂₄-alkyl or alkoxy radical or an alkylene oxide radical H(OCₘH₂ₘ)ₙ where m=1 to 6 and n=1 to 10, or a benzyl or phenyl radical,
R₃ and R₄ are a C₁-C₃-alkyl radical and
X is one equivalent of an anion.

25. A laminate comprising an impregnating resin film according to claim 23.

26. A process for the production of film-coated material having surfaces provided with antistatic treatment which comprises impregnating the resin liquor according to claim 13 into said material.

27. The process for curing aqueous condensates based on melamine and formaldehyde which comprises using an aqueous curing agent mixture comprising
(B) from 60 to 90% by weight, based on the curing agent mixture, of one or more quaternary ammonium compounds of the general formula I
(R₁R₂R₃R₄N⁺)X⁻ (I)
where
R₁ is a C₉-C₂₄-alkyl or alkoxy radical or an alkylene oxide radical H(OCₘH₂ₘ)ₙ
where m=1 to 6 and
n=1 to 10,
if R₂ is not an alkylene oxide radical where
n=1, and
n=2 to 10,
if R₂ is an alkylene oxide radical where n=1,
R₂ is a C₁-C₂₄-alkyl or alkoxy radical or an alkylene oxide radical H(OCₘH₂ₘ)ₙ where m=1 to 6 and n=1 to 10, or a benzyl or phenyl radical,
R₃ and R₄ are a C₁-C₃-alkyl radical and
X is one equivalent of an anion
(C) from 10 to 40% by weight, based on the curing agent mixture, of an aqueous curing agent solution.
